(19) United States
(12) Patent Application Publication
(10) Pub. No.: US 2019/0194369 A1
(43) Pub. Date: Jun. 27, 2019

(54) POLYPROPYLENE RESIN COMPOSITION FOR LASER WELDING AND MOLDED PRODUCT FOR VEHICLE INCLUDING THE SAME

(71) Applicants: Hyundai Motor Company, Seoul (KR); Kia Motors Corporation, Seoul (KR); LG Hausys, Ltd., Seoul (KR); Lotte Chemical Corporation, Seoul (KR)

(72) Inventors: Hyun Kyung Kim, Hwaseong (KR); Hee Joon Lee, Seoul (KR); Jae Youn Kim, Daejeon (KR); Seung Wook Park, Daejeon (KR); Se Jeon Lee, Cheongju (KR); Chun Ho Park, Cheongju (KR)

(21) Appl. No.: 16/210,772

(22) Filed: Dec. 5, 2018

(30) Foreign Application Priority Data
Dec. 26, 2017 (KR) 10-2017-0179697

(51) Int. Cl. C08F 210/06; C08F 210/16; C08F 212/08; C08L 23/14; C08K 3/013; C08K 5/00; B29C 65/16

(52) U.S. Cl. CPC C08F 210/06; C08F 210/16; C08F 212/08; C08L 23/14; C08K 3/013; C08F 2800/20; C08K 5/0041; C08K 5/0075; B29C 65/1635; C08F 2500/01; C08F 2500/15; C08K 5/005

(57) ABSTRACT

Disclose herein a polypropylene resin composition for laser welding, which includes a base resin, a thermoplastic elastomer, an inorganic filler, and an organic pigment. The base resin includes an isotactic polypropylene resin and an atactic polypropylene resin.

### CROSS-REFERENCE TO RELATED APPLICATION

This application claims under 35 U.S.C. § 119(a) the benefit of priority to Korean Patent Application No. 10-2017-0179697 filed on Dec. 26, 2017, the entire contents of which are incorporated herein by reference.

### TECHNICAL FIELD

The present invention relates to a polypropylene resin composition for laser welding and a molded product for a vehicle including the same.

### BACKGROUND

In recent years, an increasing interest in environment and energy has brought an increasing need for reducing thicknesses of plastic components and for reducing the weight of vehicles for improving fuel efficiency and resolving air pollution in the vehicle industry, for example in the automotive industry.

Accordingly, an attempt has been made in recent years to reduce the weight of the vehicle by reducing the thickness of its components. When a product is manufactured with reduced thickness, the appearance quality of the product may be deteriorated during the process of welding the product. In the related arts, a variety of holders and brackets have been manufactured and welded by using a conventional ultrasonic vibration. However, this welding method using frictional heat generated by lateral vibration causes deterioration of aesthetics with respect to the welded surface and back surface of the basic material by pressurization and heat.

When the thickness of the vehicle is substantially reduced, deformation, wrinkles, shrinkage, or the like may occur between the product to be welded and the basic material, thereby deteriorating the quality of the molded product. Therefore, when a thin product is manufactured, a laser welding method has been used for maintaining the high quality and reliability of the external appearance of the product instead of the ultrasonic vibration method.

The laser plastic welding has been used as a method of bonding two basic materials due to heat generated by converting the vibration of activated molecules into kinetic energy while a laser beam transmits from an upper layer (transmissive material) to a lower layer (absorbent material).

However, a conventional polypropylene resin composition may not be used as a light transmissive material, because a color using a convention inorganic pigment containing carbon black series may absorb light and a welding force is significantly decreased due to low laser transmittance. Thus, only colorless polypropylene with no inorganic filler can be welded alone with laser. However, if the conventional polypropylene resin is used alone, it may be gently deformed or broken due to impact because it does not satisfy the mechanical properties of the product to be welded thereto, and it may implement only a limited color. To resolve these problems, there is a need for a polypropylene composition, as a basic material for welding a thin product, which satisfies mechanical properties, enabling laser welding, and implementing a color.

The above information disclosed in this Background section is only for enhancement of understanding of the background of the invention and therefore it may contain information that does not form the prior art that is already known in this country to a person of ordinary skill in the art.

### SUMMARY OF THE INVENTION

In preferred aspects, the present invention provides a polypropylene resin composition for laser welding, which may have high transmittance while maintaining mechanical strength high, and implementing a color.

The term “transmittance” as used herein refers to a fraction of an intensity or energy of the light passed through a substance to an intensity or energy of the light radiated toward the substance (i.e. initial intensity). The transmittance may be measured at the fixed wavelength and indicate the absorbance, or absorption of radiation or energy based on the light-absorbing molecular structures of the substance.

As referred to herein, high transmittance may indicate a transmission of at least 50% of initial radiation such as visible light, more typically a transmission of about 60%, 70%, 80% or 90% of initial radiation such as visible light.

Moreover, the present invention provides a molded product for a vehicle including a polypropylene resin composition for laser welding as described herein.

In one preferred embodiment, a polypropylene resin composition for laser welding that may include a base resin, a thermoplastic elastomer, an inorganic filler, and an organic pigment. The base resin may include an isotactic polypropylene resin and an atactic polypropylene resin.

The term “thermoplastic elastomer” as used herein refers to a copolymer or a mixture of polymers that includes a polymer of thermoplastic property and a polymer of elastomer. In certain preferred embodiments, the thermoplastic elastomer may be added to a resin used for injection molding.

The term “filler” as used herein refers to a material that is typically incorporated into a resin (e.g., polymeric resin composition) in order to modify the properties of the resin. The term “inorganic filler” as used herein refers to an inorganic material (non organic material) used as a filler, including elements other than only carbon such as P, S, Si, O, N, B, metals, halogen and the like.

The term “organic pigment” as used herein refers to an organic molecule based on carbon chains and carbon rings, which may absorb or emit a light or visible light at a certain range of wave length. The organic pigment typically generates colors within the range of 400-700 nm. The organic pigment may include natural organic pigment and synthetic organic pigments or petroleum compound.

The term “isotactic polypropylene” or “isotactic polypropylene resin” as used herein refers to a polypropylene where pendant groups (e.g., alkyl group such as methyl group) are oriented on one side of the carbon backbone, or substantially (e.g., at least 70%, 80%, 90%, or greater of all methyl groups) oriented on one side of the carbon backbone, such that the isotactic polypropylene has greater structural rigidity or crystallinity to non-isotactic polymer (e.g., polypropylene).

The term “atactic polypropylene” or “atactic polypropylene resin” as used herein refers to an amorphous polypropylene resin, which may be due to random orientation of the pendant groups (e.g., alkyl groups such as methyl groups) along the polymer chain. What is meant by “amorphous” refers to be non-crystalline, for example, not having definite form nor apparent structural rigidity. The atactic polypropylene resin may be a random copolymer obtained, or obtainable, by polymerization of a homopolypropylene resin with one comonomer selected from a group consisting of propylene, ethylene, butylenes, and octene, or a block copolymer of polypropylene and ethylene-propylene rubber.

The atactic polypropylene resin may have a weight-average molecular weight of about 1,000,000 g/mol to 2,500,000 g/mol.

The polypropylene resin composition may include the base resin in an amount of about 40 to 90 parts by weight, based on 100 parts by weight of the polypropylene resin composition.

The base resin may include an amount of about 50 to 100 parts by weight of the atactic polypropylene resin, based on 100 parts by weight of the isotactic polypropylene resin.

The thermoplastic elastomer may include an olefin copolymer of ethylene and α-olefin with a carbon number of 3 to 30, or a styrene-based copolymer.

The polypropylene resin composition may include the thermoplastic elastomer in an amount of about 1 to 50 parts by weight, based on 100 parts by weight of the base resin.

The inorganic filler may have a needle shape, and have a mean diameter of about 3 to 20 μm and an aspect ratio of about 10 to 100.

The polypropylene resin composition may include the inorganic filler in an amount of about 1 to 50 parts by weight, based on 100 parts by weight of the base resin.

The polypropylene resin composition may include the organic pigment in an amount of about 0.01 to 1 parts by weight, based on 100 parts by weight of the base resin.

The polypropylene resin composition may further include at least one of an antioxidant, a photo stabilizer, a thermal stabilizer, and an antistatic agent.

In another preferred embodiment, a molded product for a vehicle may include the polypropylene resin composition for laser welding, as described herein.

The polypropylene resin composition may implement a color to the molded product.

The molded product may have a laser transmittance of from about 30% to less than about 100%, and a welding strength of about 1000 to 2000 N.

Further provided herein is a vehicle that may include the molded product as described herein.

Other aspects and preferred embodiments of the invention are discussed infra.

The above and other features of the invention are discussed infra.

### DETAILED DESCRIPTION

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprise”, “include”, “have”, etc. when used in this specification, specify the presence of stated features, regions, integers, steps, operations, elements and/or components but do not preclude the presence or addition of one or more other features, regions, integers, steps, operations, elements, components, and/or combinations thereof.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. Moreover, the vehicle may refer to a vehicle used to transport objects and/or passengers. For example, the vehicle includes a land vehicle, a marine vehicle, and an air vehicle. Examples of the land vehicle may include automobiles such as passenger cars, vans, trucks, trailer trucks, and sports cars, bicycles, motorcycles, trains, etc. Examples of the marine vehicle may include ships, submarines, etc. Examples of the air vehicle may include airplanes, hang-gliders, hot-air balloons, helicopters, and small flight vehicles such as drones.

Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The above and other objects, features and other advantages of the present invention will be more clearly understood from the following detailed description taken in conjunction with the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

Throughout the disclosure, the same reference numbers will be used throughout the drawings to refer to the same or like parts. In the drawings, the dimension of each structure is exaggerated or schematically illustrated for convenience of description and clarity. It will be understood that, although the terms first, second, the like. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the singular forms are intended to include the plural forms as well, unless the context clearly indicates otherwise.

Hereinafter, a polypropylene resin composition for laser welding and a molded product for a vehicle including the same according to various exemplary embodiments of the present invention will be described.

The polypropylene resin composition for laser welding according to an exemplary embodiment of the present invention may include a base resin, a thermoplastic elastomer, an inorganic filler, and an organic pigment.

The base resin may include an isotactic polypropylene resin and an atactic polypropylene resin.

Typically, when a polypropylene resin composition includes isotactic polypropylene as a polypropylene resin, it may have improved mechanical properties due to high crystallinity but may have low light transmittance.

In addition, the polypropylene resin composition may have reinforced impact resistance using a thermoplastic elastomer but may have low stiffness. When other materials are used to reinforce mechanical properties such as fluidity, flexural strength, and tensile strength of this polypropylene resin composition, it may not achieve a sufficient effect due to problems relating to compatibility between the polypropylene resin and other resins or inorganic compounds.

Accordingly, the polypropylene resin composition for laser welding according to the embodiment of the present invention includes the isotactic polypropylene resin as the base resin to render high mechanical properties due to high crystallinity

Since the polypropylene resin composition for laser welding may include the atactic polypropylene resin with a high weight-average molecular weight together with the isotactic polypropylene resin, it may have high tensile strength, modulus of flexural elasticity, impact strength and light transmittance together. The weight-average molecular weight of the atactic polypropylene resin may be of about 1,000,000 g/mol to 2,500,000 g/mol. The atactic polypropylene resin may have a laser light transmittance from about 60% to less than about 100%. When the laser light transmittance is less than about 60%, sufficient transmittance may not be obtained since the atactic polypropylene resin is applied to a vehicle. On the other hand, when the laser light transmittance is equal to or greater than about 100%, the atactic polypropylene resin may not be manufactured.

The atactic polypropylene resin may be, for example, a random copolymer obtained by polymerization of a homopolypropylene resin with one comonomer selected from the group consisting of propylene, ethylene, butylene and octene, or a block copolymer of polypropylene and ethylene-propylene rubber.

The base resin may be included in an amount of about 40 to 90 parts by weight, based on 100 parts by weight of the polypropylene resin composition for laser welding. The base resin may have excellent machinability and mechanical properties together within the above range.

The base resin may include an amount of about 50 to 100 parts by weight of the atactic polypropylene resin, based on 100 parts by weight of the isotactic polypropylene resin. When the amount of the atactic polypropylene resin is less than about 50 parts by weight, laser welding may be deteriorated since the light transmittance of the atactic polypropylene resin is reduced to about 25% or less. On the other hand, when the amount of the atactic polypropylene resin is greater than about 100 parts by weight, mechanical properties such as tensile strength and modulus of flexural elasticity may be reduced.

Since the polypropylene resin composition includes the isotactic polypropylene resin and the atactic polypropylene resin which have different conformations as the base resin, high light transmittance of the resin or the product made from the same may be obtained while maintaining high tensile strength, modulus of flexural elasticity, and impact strength even when it is used as a material welded to a thin molded product.

The thermoplastic elastomer may increase impact strength and improve laser transmittance. In addition, the thermoplastic elastomer may have high light transmittance.

The thermoplastic elastomer may include, for example, an olefin copolymer of ethylene and α-olefin with a carbon number of 3 to 30, or a styrene-based copolymer. The α-olefin with a carbon number of 3 to 30 may be, for example, one α-olefin compound selected from the group consisting of 1-propene, 1-butene, 1-pentene, 4-methyl-1-pentene, 1-hexene, 1-heptene, 1-octene, 1-decene, 1-undecene, 1-dodecene, 1-tetradecene, 1-hexadecene, 1-eicosene, and a combination thereof. For example, the olefin copolymer may be a block copolymer.

The term “-based” used herein may mean that it includes compounds corresponding to “-based”.

The styrene-based copolymer may include, for example, at least one of a styrene-ethylene copolymer, a styrene-butylene copolymer, a styrene-butylene-styrene copolymer, and a styrene-ethylene-butylene-styrene copolymer. For example, the styrene-based copolymer may be a block copolymer.

The thermoplastic elastomer may be included in an amount of about 1 to 50 parts by weight, based on 100 parts by weight of the base resin. When the amount of the thermoplastic elastomer is less than about 1 part by weight, the impact strength may be reduced. On the other hand, when the amount of the thermoplastic elastomer is greater than about 50 parts by weight, the dispersion force and the flexibility may be reduced. Thus, since the laser light transmittance of the thermoplastic elastomer is equal to or greater than about 65% within the above range, the high light transmittance and bond strength of the polypropylene resin composition for laser welding may be maintained when the resin composition is applied to the transmissive welding product.

The inorganic filler may render mechanical strength and high light transmittance required for laser welding.

The inorganic filler may have a needle shape. The inorganic filler may be, for example, at least one of wollastonite, mica, whisker, and acicular talc.

The inorganic filler may have a mean diameter of about 3 to 20 μm. When the mean diameter of the inorganic filler is less than about 3 μm, compatibility of the inorganic filler with the base resin may be reduced and stiffness may be reduced due to its large surface area. On the other hand, when the mean diameter of the inorganic filler is greater than about 20 μm, laser welding may not be performed sufficiently since mechanical properties such as impact strength are reduced and the inorganic filer has low light transmittance.

The inorganic filler may have an aspect ratio of about 10 to 100. When the aspect ratio of the inorganic filler is less than about 10, the modulus of flexural elasticity and the stiffness of the molded product may be reduced and the laser welding of the molded product may be deteriorated since the inorganic filler has low light transmittance. When the aspect ratio of the inorganic filler is greater than about 100, mechanical properties such as impact strength may be reduced and the inorganic filler may be easily deformed and broken when it is applied to the molded product.

The inorganic filler may be included in an amount of about 1 to 50 parts by weight, based on 100 parts by weight of the base resin. When the amount of the inorganic filler is less than 1 part by weight, mechanical properties may not be improved. On the other hand, when the amount of the inorganic filler is greater than about 50 parts by weight, the impact strength and light transmittance of the polypropylene resin composition for laser welding may be reduced.

The organic pigment may render a color when the polypropylene resin composition for laser welding is used for the molded product for a vehicle. The organic pigment may include, for example, at least one of a yellow organic pigment, a red organic pigment, a blue organic pigment, and a green organic pigment. The organic pigment may include, for example, at least one of a benzoimidazole-based pigment and an azo-based pigment.

The organic pigment is contained in an amount of about 0.01 to 1 parts by weight, based on 100 parts by weight of the base resin. When the amount of the organic pigment is less than about 0.01 part by weight, sufficient color may not be obtained when the organic pigment is used for the molded product for a vehicle. On the other hand, when the amount of the organic pigment is greater than about 1 part by weight, mechanical stiffness and light transmittance may be reduced since the amounts of other compositions are reduced.

The polypropylene resin composition for laser welding according to an exemplary embodiment of the present invention may further include at least one of an antioxidant, a photostabilizer, a thermal stabilizer, and an antistatic agent.

The antioxidant may include, for example, at least one of a phenol-based antioxidant, a phosphate-based antioxidant, and a thiodipropionate.

The photostabilizer may include, for example, at least one of a benzophenon-based photostabilizer, a benzotriazol photostabilizer, and an HALS photostabilizer.

The antistatic agent may include, for example, at least one of a stearate-based antistatic agent and an amine-based antistatic agent.

The molded product for a vehicle according to an exemplary embodiment of the present invention may include a polypropylene resin composition for laser welding. For example, the molded product for a vehicle according to an exemplary embodiment of the present invention may include an injection molded product manufactured by the polypropylene resin composition for laser welding according to the embodiment of the present invention. The polypropylene resin composition for laser welding may be included in the molded product for a vehicle to implement a color.

The molded product for a vehicle according to an exemplary embodiment of the present invention may be manufactured, for example, by melting and extruding the polypropylene resin composition for laser welding according to an exemplary embodiment of the present invention using a melting extruder with two or more axes. For example, the screw rotation speed of the melting extruder may be about 200 to 1000 rpm, and the residence time of the composition in the extruder may be about 5 to 90 seconds (sec.).

The shear flow and the elongational flow required for mulling between the resins and dispersion of the inorganic filler may be effectively induced in the melting extruder by setting the screw rotation speed of the melting extruder to be equal to or greater than about 200 rpm. In addition, the deterioration of the base resin, the inorganic filler, and the like may be prevented by setting the screw rotation speed to be less than or equal to about 1000 rpm. In addition, the resin, the inorganic filler, and the like of the composition may be sufficiently mixed and deterioration prevention and productivity improvement may be obtained by setting the residence time of the composition in the extruder to be about 5 to 90 seconds (sec.).

The molded product for a vehicle may be used as a transmissive material for laser welding, for example, automobile interior and exterior materials such as a bumper cover, a side sill molding, a door trim, and a pillar trim.

The molded product for a vehicle may have a laser transmittance of from about 30% to less than about 100%, and have a welding strength of about 1000 to 2000 N.

The molded product may have a modulus of flexural elasticity of about 2,000 to 2,800 MPa according to ASTM D790. When the modulus of flexural elasticity of the molded product is less than about 2,000 MPa, deformation and impact by external force may not be prevented when it is applied to a molded product having a thickness less than about 2.0 mm On the other hand, when the modulus of flexural elasticity of the molded product is greater than about 2,800 MPa, the laser welding and bond strength of a component for welding may be reduced since the inorganic filler is contained in a large amount.

The molded product for a vehicle may have high transmittance together with excellent mechanical properties such as high bond strength, external appearance quality of welded parts, high tensile strength, modulus of flexural elasticity, and impact strength. In addition, the molded product for a vehicle may implement a variety of colors.

### EXAMPLE

Hereinafter, the present invention will be described in more with reference to specific examples. The following examples are illustrated merely to help understanding of the present invention, and the present invention is not limited thereto.

### Example 1

A polypropylene resin composition was manufactured to include a base resin, which includes JSS-370N (PP, LOTTE Chemical Corp.) as an isotactic polypropylene resin, and UHMW aPP (melting index of 1.5 g/min, LOTTE Chemical Corp.) as an atactic polypropylene resin with a weight-average molecular weight of 1,000,000 g/mol, G-1643 as (SEBS, kraton light transmittance of 65) as a thermoplastic elastomer A, and MICA (d50 12 μm, aspect ratio of 35) as an inorganic filler A.

The isotactic polypropylene resin, the atactic polypropylene resin, the thermoplastic elastomer A, the inorganic filler, and the organic pigment were mixed at a ratio of 44:25:15:15:1 parts by weight. The organic pigment was mixed to implement a black color.

The polypropylene resin composition was extruded under the extrusion condition of an extrusion temperature of 160 to 210° C. and a screw rotation speed of 500 rpm by a two-axis extruder (screw diameter of 32 mm, L/D of 40) to form a specimen using an injection molding machine.

### Example 2

A polypropylene resin composition was manufactured in the same manner as Example 1, except that an isotactic polypropylene resin, an atactic polypropylene resin, a thermoplastic elastomer A, an inorganic filler, and an organic pigment were mixed at a ratio of 54:15:15:15:1 parts by weight.

### Comparative Example 1

A polypropylene resin composition was manufactured in the same manner as Example 1, except for mixing 59 parts by weight of UHMW aPP (melting index of 1.5 g/min, LOTTE Chemical Corp.) as an atactic polypropylene resin with a weight-average molecular weight of 1,000,000 g/mol, and 10 parts by weight of JSS-370N (PP, LOTTE Chemical Corp.) as an isotactic polypropylene resin.

### Comparative Example 2

A polypropylene resin composition was manufactured in the same manner as Example 1, except for mixing 15 parts by weight of talc with a mean diameter of 4 μm as an inorganic filler B instead of an inorganic filler A.

### Comparative Example 3

A polypropylene resin composition was manufactured in the same manner as Example 1, except for mixing 15 parts by weight of DF640 as a thermoplastic elastomer B.

TABLE 1

| | | | | Comp. | Comp. | Comp. |
|---|---|---|---|---|---|---|
| Sort | | Ex. 1 | Ex. 2 | Ex. 1 | Ex. 2 | Ex. 3 |
| Isotactic PP | Parts by | 44 | 54 | 10 | 44 | 44 |
| | weight | | | | | |
| Atactic PP | Parts by | 25 | 15 | 59 | 25 | 25 |
| | weight | | | | | |
| Thermoplastic | Parts by | 15 | 15 | 15 | 15 | |
| elastomer A | weight | | | | | |
| Thermoplastic | Parts by | | | | | 15 |
| elastomer B | weight | | | | | |
| Inorganic Filler A | Parts by | 15 | 15 | 15 | | 15 |
| | weight | | | | | |
| Inorganic Filler B | Parts by | | | | 15 | |
| | weight | | | | | |
| Organic Pigment | Parts by | 1 | 1 | 1 | 1 | 1 |
| | weight | | | | | |

### Evaluation

### Test Example 1

### Specific Gravity

The specific gravities of the specimens obtained from Examples 1 and 2 and Comparative examples 1 to 3 were measured according to ASTM D792, and their results are indicated in the following Table 2.

### Test Example 2

### Melting Index (g/10 min)

The melting indexes of the polypropylene resin compositions obtained from Examples 1 and 2 and Comparative examples 1 to 3 were measured at a temperature of 230° C. and under a load of 2.16 kg according to ASTM D1238, and their results are indicated in the following Table 2.

### Test Example 3

### Tensile Strength

The tensile strengths of the specimens obtained from Examples 1 and 2 and Comparative examples 1 to 3 were measured at a temperature of 23° C. according to ASTM D638 wherein the standard of each specimen is 165×13×3.2 mm and a crosshead has a speed of 50 mm/min, and their results are indicated in the following Table 2.

### Test Example 4

### Modulus of Flexural Elasticity

The moduli of flexural elasticity of the specimens obtained from Examples 1 and 2 and Comparative examples 1 to 3 were measured according to ASTM D790 wherein the standard of each specimen is 12.7×127×6.4 mm and a crosshead has a speed of 10 mm/min, and their results are indicated in the following Table 2.

### Test Example 5

### IZOD Impact Strength

The IZOD impact strengths of the specimens obtained from Examples 1 and 2 and Comparative examples 1 to 3 were measured at room temperature (23° C.) according to ASTM D256 wherein the standard of each specimen is 63.5×12.7×6.4 mm, and their results are indicated in the following Table 2.

### Test Example 6

### Transmittance

The specimens obtained from Examples 1 and 2 and Comparative examples 1 to 3 were measured wherein the standard of each specimen is 60×60×1.5 mm, a laser irradiation wavelength was 980 nm±2%, an irradiation power was 10 mW±2%, and an irradiation distance (distance between a light source and a specimen) was 48±2 mm, and their results are indicated in the following Table 2.

### Test Example 7

### Bond Strength

The bond strengths of the specimens such as those of Test Example 6 obtained from Examples 1 and 2 and Comparative examples 1 to 3 were measured under the condition that a maximum load was in the range of a load cell of 15 to 85% by a tensile tester in the state in which the overlap portions of a transmissive material and an absorbent material were welded with laser. The bond strengths of the specimens were measured under the welding condition that a wavelength is 980 nm±2%, a power was 200 W, and a speed was 10 m/s, at an inter-clamp distance of 60 mm, and at a tension speed of 50 mm/min, and their results were indicated in the following Table 2.

### Test Example 8

### External Appearance of Weld Intersection

The laser welding portion of the specimen manufactured in Test Example 6 was observed by an optical microscope with ×50 magnifications, and a minimum of three different surfaces are cut to expose the intersection of the welding portion and then whether each of the cut surfaces is defective is checked. Their results are indicated in the following Table 2.

TABLE 2

| | | | | Comp. | Comp. | Comp. |
|---|---|---|---|---|---|---|
| Sort | | Ex. 1 | Ex. 2 | Ex. 1 | Ex. 2 | Ex. 3 |
| Melting Index | g/10 | 29 | 29 | 6.5 | 26 | 28 |
| | min | | | | | |
| Specific Gravity | — | 1 | 1 | 1 | 1 | 1 |
| Tensile Strength | MPa | 20.1 | 20.1 | 18.9 | 21 | 19.2 |
| Modulus of | MPa | 2,160 | 2,360 | 1,600 | 2,120 | 1,780 |
| Flexural Elasticity | | | | | | |
| IZOD (@23° C.) | J/m | 311 | 281 | 429 | 284 | 314 |
| Transmittance | % | 39 | 34 | 55 | 24 | 26 |
| Bond Strength | N | 1191 | 1081 | 1289 | 841 | 845 |
| External | N | Good | Good | Good | Wrinkle | Not |
| Appearance of | | | | | Defor- | welded, |
| Weld Intersection | | | | | mation | Crack |

As indicated in the Table 2, when the atactic polypropylene resin with a high weight-average molecular weight was not used, the laser transmittance was low and the strength of the welding portion is reduced. When each component was included alone in the composition, the properties such as tensile strength, modulus of flexural elasticity, and impact strength of the molded product manufactured of the polypropylene resin composition were not evenly satisfied. In addition, the materials of Comparative Examples 2 and 3 were not suitable for a material for laser welding since the light transmittance of the molded product was low and the bond strength and external appearance of the laser welding portion occurred due to the difference in light transmittance of the selected inorganic filler and thermoplastic elastomer even though mechanical properties are excluded.

On the other hand, in Examples 1 and 2 of including both the isotactic polypropylene resin and the atactic polypropylene resin, they had a high light transmittance over 30% while having excellent mechanical properties, and high bond strength, and the external appearance of the welding portion was excellent.

According to various exemplary embodiments of the present invention, the polypropylene resin composition for laser welding may be suitable for laser welding, have high transmittance while keeping mechanical strength high, and implement a color.

The molded product for a vehicle according to various exemplary embodiments of the present invention may have high transmittance while keeping mechanical strength high, and implement a color.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A polypropylene resin composition for laser welding, comprising:
a base resin;
a thermoplastic elastomer;
an inorganic filler; and
an organic pigment,
wherein the base resin comprises an isotactic polypropylene resin and an atactic polypropylene resin.

2. The polypropylene resin composition of claim 1, wherein the atactic polypropylene resin is a random copolymer obtained by polymerization of a homopolypropylene resin with one comonomer selected from a group consisting of propylene, ethylene, butylenes, and octene, or a block copolymer of polypropylene and ethylene-propylene rubber.

3. The polypropylene resin composition of claim 1, wherein the atactic polypropylene resin has a weight-average molecular weight of 1,000,000 g/mol to 2,500,000 g/mol.

4. The polypropylene resin composition of claim 1, wherein the polypropylene resin composition comprises the base resin in an amount of 40 to 90 parts by weight, based on 100 parts by weight of the polypropylene resin composition.

5. The polypropylene resin composition of claim 1, wherein the base resin comprises an amount of 50 to 100 parts by weight of the atactic polypropylene resin, based on 100 parts by weight of the isotactic polypropylene resin.

6. The polypropylene resin composition of claim 1, wherein the thermoplastic elastomer comprises an olefin copolymer of ethylene and α-olefin with a carbon number of 3 to 30, or a styrene-based copolymer.

7. The polypropylene resin composition of claim 1, wherein the polypropylene resin composition comprises the thermoplastic elastomer in an amount of 1 to 50 parts by weight, based on 100 parts by weight of the base resin.

8. The polypropylene resin composition of claim 1, wherein the inorganic filler is formed in a needle shape, and has a mean diameter of 3 to 20 μm and an aspect ratio of 10 to 100.

9. The polypropylene resin composition of claim 1, wherein the polypropylene resin composition comprises the inorganic filler in an amount of 1 to 50 parts by weight, based on 100 parts by weight of the base resin.

10. The polypropylene resin composition of claim 1, wherein the polypropylene resin composition comprises the organic pigment in an amount of 0.01 to 1 parts by weight, based on 100 parts by weight of the base resin.

11. The polypropylene resin composition of claim 1, further comprising at least one of an antioxidant, a photostabilizer, a thermal stabilizer, and an antistatic agent.

12. A molded product for a vehicle, comprising the polypropylene resin composition for laser welding of claim 1.

13. The molded product of claim 12, wherein the polypropylene resin composition the molded product implements a color to the molded product.

14. The molded product of claim 12, wherein the molded product has a laser transmittance from 30% to less than 100%, and a welding strength of 1000 to 2000 N.

15. A vehicle comprising a molded product of claim 12.
